(19) United States
(12) Patent Application Publication
(10) Pub. No.: US 2004/0151967 A1
(43) Pub. Date: Aug. 5, 2004

(54) Component part for fuel battery

(76) Inventor: Tomohiro Inoue, Fujisawa-shi (JP)

Correspondence Address: JACOBSON HOLMAN PLLC, 400 SEVENTH STREET N.W., SUITE 600, WASHINGTON, DC, 20004, US

(21) Appl. No.: 10/731,479

(22) Filed: Dec. 10, 2003

(30) Foreign Application Priority Data
Feb. 4, 2003 (JP) 2003-026683

(51) Int. Cl. H01M 2/00

(52) U.S. Cl. 429/34

(57) ABSTRACT

To provide a component part for a fuel battery having a pair of separator plates and a gasket interposed between both the separator plates, and being structured such that the separator plates (2, 3) are closely attached to each other at a time of assembling a cell, in which the gasket can be formed by every kinds of manufacturing methods and a gasket reaction force can be set to a desired magnitude, the separator plates are arranged in parallel to each other in a state of having a gap between contact surfaces thereof opposing to each other in parallel to each other in a state of having a gap, a gasket is arranged in a gasket groove, which is provided in one or both of the separator plates, and adhered to each of both the separator plates, and the gasket is compressedly deformed within the gasket groove by closely attaching of both the separator plates to each other with the contact surfaces.

### BACKGROUND OF THE INVENTION

1. Field of the Invention

The present invention relates to a component part for a fuel battery, and more particularly to a component part for a fuel battery having a pair of separator plates and a gasket interposed between both the separator plates. The component part for the fuel battery in accordance with the present invention is mainly used as a cooling water circulation system separator in a proton-exchange membrane fuel cell stack because a pair of separator plates are closely attached to each other at a time of assembling the cell.

2. Description of the Conventional Art

In the proton-exchange membrane fuel cell, fluids such as hydrogen oxygen or air, and cooling water are used, and each of the fluids is separated by a high polymer electrolyte membrane, a separator or the like. Accordingly, a gasket for sealing each of the fluids is an important factor for structuring the apparatus. However, since electric conductivity, thermal conductivity and a fluid impermeability are required all together in the separator among the fluid separating parts, the separator is generally formed by a plate made of a material having very low strength such as calcined carbon, resin contained carbon, amorphous carbon or the like. Accordingly, when the gasket mentioned above employs an O-ring or a flat gasket having a large reaction force which has been used in a conventional wide-use equipment, there is a case that the separator plate is broken due to the reaction force at a time of assembling the cell.

As a countermeasure about the problem mentioned above, for example, in the invention described in Japanese Unexamined Patent Publication No. 2000-133288 (patent document 1), there is employed a means for reducing the reaction force generated in the gasket by forming the gasket into a chevron cross sectional shape, or the like. However, in order to form the gasket having a regular shape such as the chevron shape or the like, there is a disadvantage that it is necessary to employ a compression molding method or an injection molding method in which a cost is comparatively high and a production process is comparatively complex because a metal mold is used, and it is hard to employ a dispenser method or a screen printing method in which a cost is comparatively low and a production process is comparatively simple since no metal mold is used. For example, if the gasket having the chevron cross sectional shape is formed in accordance with the dispenser method, the cross sectional shape of the gasket can not be arranged regularly all around a periphery, so that a dispersion is generated in a magnitude of the reaction force generated at a time of being used in a unit product or a part of a seal surface within one product, whereby an obstacle is generated in a sealing performance of the gasket.

Further, as a countermeasure thereof, for example, in the invention described in Japanese Unexamined Patent Publication No. 2001-110436 (patent document 2), there is proposed a method of sealing various members only by an adhesive agent without using the gasket. However, in this case, since the seal reaction force is zero, there is absolutely no reliability about the sealing performance such as leakage is generated due to little deterioration of the seal for example.

### SUMMARY OF THE INVENTION

Taking the matters mentioned above into consideration, an object of the present invention is to provide a component part for a fuel battery having a pair of the separator plates and a gasket interposed between both the separator plates, and structured such that a pair of separator plates are closely attached to each other at a time of assembling the cell, in which the gasket can be formed by every kinds of manufacturing methods and a gasket reaction force can be set to a desired magnitude.

In order to achieve the object mentioned above, in accordance with the present invention, there is provided a component part for a fuel battery comprising:

a pair of separator plates which are arranged in parallel to each other in a state of having a gap between contact surfaces thereof opposing to each other; and

a gasket arranged in a gasket groove, which is in one or both of the separator plates, and adhered to each of both the separator plates,

wherein the gasket is compressedly deformed within the gasket groove at a time of both the separator plates being closely attached to each other with the contact surfaces for assembling of the fuel battery cell.

In the invention described in the patent document 1 mentioned above, the cross sectional shape of the gasket is formed in the chevron shape for the purpose of reducing the gasket reaction force, because the structure is made such that the gasket is adhered only to one separator and is closely contacted to another separator plate without being adhered (is closely contacted by the chevron-shaped top end portion). Accordingly, it is not possible to use the dispenser method and the screen printing method which are comparatively simple as the gasket forming means. On the contrary, in accordance with the component part for the fuel battery on the basis of the present invention having the structure mentioned above, since the gasket is adhered to each of a pair of separator plates, it is possible to form the gasket without limiting to the chevron cross sectional shape, whereby it is possible to form the gasket irrespective of the manufacturing method.

Further, since a pair of separator plates are arranged in parallel with keeping the gap between the separators, and the gasket is compressedly deformed within the gasket groove at a time of closely attaching both the separator plates to each other for assembling the cell, a desired magnitude of gasket reaction force can be set by suitably regulating the size of the gap between a pair of separator plates at a time of manufacturing. Before assembling the cell, a pair of separator plates are not closely attached to each other, and the gasket is not compressed. Accordingly, no reaction force is generated in the gasket. In this case, it is preferable as mentioned above that the gasket reaction force is small in general.

Further, since a pair of separator plates are set in the state of being closely attached to each other at a time of being used, it is preferable that the component part for the fuel battery in accordance with the present invention having the structure mentioned above is used as the cooling water circulation system separator in which it is necessary to closely attach the separators to each other for the purpose of preventing an electric conductivity from being damaged.

In this case, the present application includes the following technical matters.

In other words, in order to achieve the object mentioned above, a component part for a fuel battery and a manufacturing method thereof proposed by the present application are provided with the following contents.

(1) A method of manufacturing a gasket for a fuel battery in which a fuel battery cell having a groove portion to hold a gasket material in one or both of separator plates and being formed by closely attaching the separator plate contact surfaces to each other, is assembled by forming the gasket material and adhering the gasket material to the separator plates in a state of a gap being kept between the contact surfaces, and thereafter pressing the separator plates so as to closely attach.

(2) A method of manufacturing a gasket for a fuel battery as recited in the item (1) mentioned above, in which a gap D between the contact surfaces is set such that a gap d1 of the gasket groove in a state of the gap being kept between the contact surfaces is 101 to 150% of a gap d2 of the gasket groove in a state of the separator plates being closely attached (or D=d1−d2 and d2<d1<1.5 d2).

(3) In accordance with the manufacturing method mentioned above, the following effects can be achieved.

(3-1) Since the gasket material constituted by an elastic body is adhered to the separator plates clamping the gasket material, and the reaction force by the gasket material of the elastic body is applied, it is possible to obtain a high reliability with respect to a sealing performance even in the structure in which the reaction force of the elastic body is set small.

(3-2) Since the gap between the separator plates is regulated in such a manner that a desired reaction force can be obtained at a time of being closely attached, it is possible to achieve a high sealing performance on the basis of a combined effect with the adhesive agent even in the case of the gasket generating a low reaction force-.

(3-3) In the case that the elastic body before being cured is pressed to a predetermined height and the reaction force at a time of sealing is set small, in comparison with the conventional chevron-shaped gasket material sealing only by means of the reaction force of the elastic body, it is possible to reduce an influence of forming unevenness in the elastic body, and it is possible to employ an elastic body applying means such as the dispenser method, the screen printing method or the like.

(3-4) In the case that the top end portion of the elastic body is formed in a flat surface, it is possible to aim an improvement of the sealing performance caused by an increase of the seal area even under the low reaction force, in comparison with the conventional chevron-shaped gasket.

(3-5) In the gasket material in accordance with the present invention, even in the case that the elastic body is deteriorated so as to reduce the reaction force at a time of being used, and a negative reaction force is applied, it is possible to delay the leakage of the fluid to be sealed (a seal service life can be extended) because the elastic body is adhered to the separator plate surfaces.

### BRIEF DESCRIPTION OF THE DRAWINGS

FIGS. 1A, 1B and 1C are views showing a component part for a fuel battery in accordance with an embodiment of the present invention, in which FIG. 1A is a cross sectional view on a manufacturing process, FIG. 1B is a cross sectional view in a complete state, and FIG. 1C is a cross sectional view in a use state;

FIGS. 2A, 2B and 2C are views showing a component part for a fuel battery in accordance with another embodiment of the present invention, in which FIG. 2A is a cross sectional view on a manufacturing process, FIG. 2B is a cross sectional view in a complete state, and FIG. 2C is a cross sectional view in a use state; and

FIGS. 3A and 3B are views showing a component part for a fuel battery in accordance with a comparative embodiment, in which FIG. 1A is a cross sectional view on a manufacturing process, and FIG. 1B is a cross sectional view in a complete state and in a used state.

### DESCRIPTION OF THE PREFERRED EMBODIMENTS

A description will be given next of an embodiment in accordance with the present invention with reference to the accompanying drawings. A component part for a fuel battery in accordance with the embodiment is used as a cooling water circulation system separator in a proton-exchange membrane fuel cell stack.

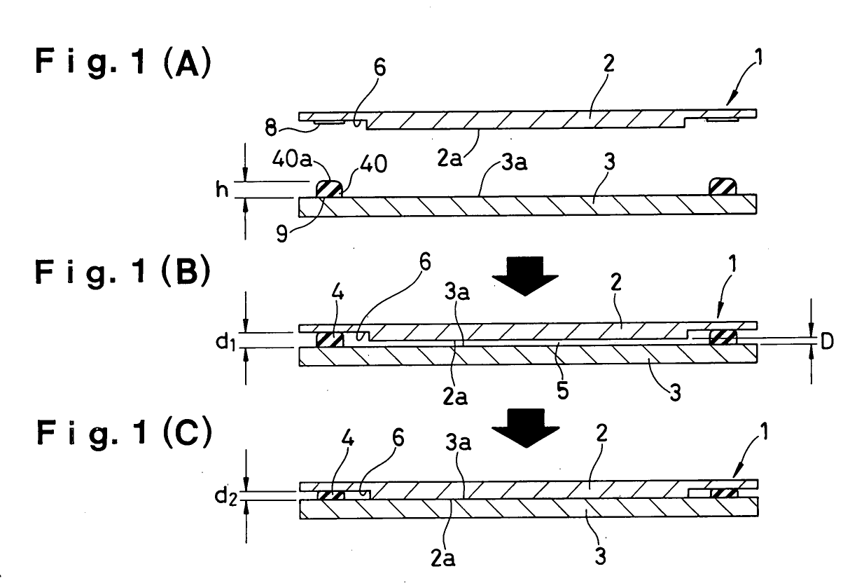

FIGS. 1A, 1B and 1C show a component part 1 for a fuel battery in accordance with the embodiment, in which FIG. 1A is a cross sectional view on a manufacturing process, FIG. 1B is a cross sectional view in a complete state (before assembling a cell), and FIG. 1C is a cross sectional view in a use state (after assembling the cell), respectively.

The fuel battery component part 1 in accordance with the embodiment is structured as follows.

As shown in FIG. 1B, the fuel battery component part 1 is constituted by a pair of separator plates 2 and 3 (upper and lower separator plates in the drawing) and a gasket 4 interposed between a pair of the separator plates 2 and 3. The separator plates 2 and 3 are formed by a calcined carbon, a resin contained carbon, an amorphous carbon or the like, and the gasket 4 is formed by a rubber-like elastic body.

A pair of the separator plates 2 and 3 have a gap 5 of a predetermined size D between contact surfaces 2a and 3a opposing to each other, and are arranged in parallel to each other via the gap 5.

The gasket 4 is arranged in a gasket groove 6 provided in a lower surface of one separator plate 2 which is arranged in the upper side in the drawing, and is adhered to each of a pair of the separator plates 2 and 3.

Further, the fuel battery component part is structured, as shown in FIG. 1C, such that when a pair of the separator plates 2 and 3 are contact to each other by the respective closely attached surfaces 2a and 3a at a time of being assembled as the fuel battery cell, the size of the gasket groove 6 is reduced from d1 to d2, whereby the gasket 4 is compressedly deformed within the gasket groove 6 so as to generate the reaction force.

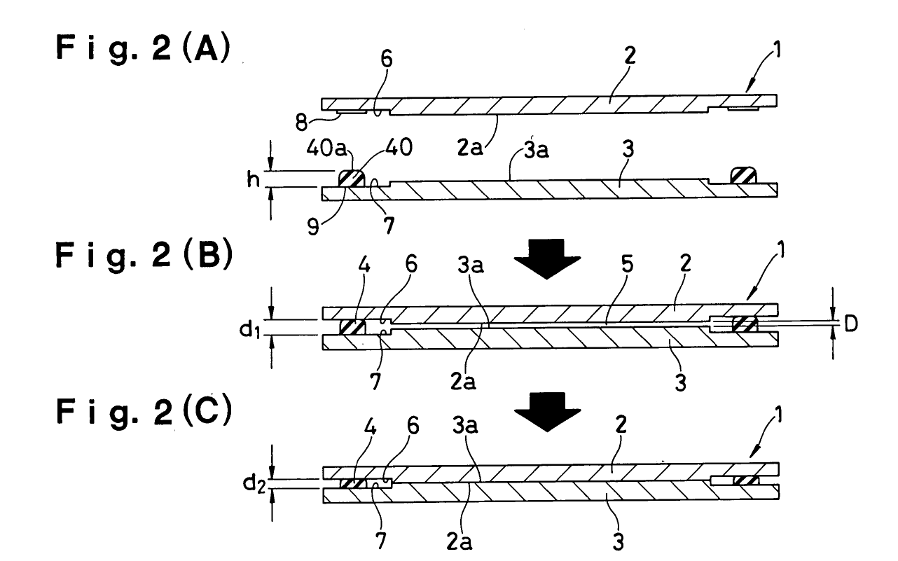

Next, a description will be given of a method of manufacturing the fuel battery component part 1. First, FIG. 1A shows a state in which an elastic body 40 before being cured and used as the gasket 4 is applied or primarily molded on the separator plate 3 arranged in the lower side in the drawing. The gasket groove 6 to which the gasket 4 is attached is previously formed on the separator plate 2 arranged in the upper side in the drawing before this stage. In this case, in this embodiment, the gasket groove 6 is formed on only one separator 2, however, the gasket grooves 6 and 7 may be respectively formed on a pair of the separator plates 2 and 3, as shown in FIG. 2.

In this case, it is desirable in view of the process that the elastic body 40 is applied by means of the dispenser method, the screen printing method or the like. However, the elastic body 40 may be primarily molded by the compression molding or the injection molding by using the metal mold. In this case, the hardening process such as heating or the like is finished before the elastic body 40 is completely cured. Further, an elastic body 40 which is formed in accordance with hardening by heating may be attached as a gasket completed product onto the separator plate 3 in accordance with a post-adhesion, and in this case, a height h of the elastic body 40 is set such that the gap 5 between a pair of the separator plates 2 and 3 is a predetermined distance.

The cross sectional shape of the elastic body 40 may be formed in a chevron shape as in the prior art mentioned above, however, since not so high reaction force is required in the gasket 4 in accordance with the effect of the present invention, it is desirable to form a top end portion 40a of the elastic body 40 in a flat shape for the purpose of increasing an adhesive force by expansion of the adhesion surface to the separator plated 2 and 3.

The kind of the elastic body 40 includes an elastic material of a silicone group, a fluorine group, a butyl group, an EPDM or an epoxy group, and the elastic material of the silicone group is preferably employed. In the case that the elastic material to be employed has an adhesion property to the separator plates 2 and 3, only the elastic body 40 is applied or primarily molded on the separator plate 3, however, in the case that a sufficient adhesive force can not be obtained, the separator plates 2 and 3 and the elastic body 40 are adhered after adhesive agents 8 and 9 are applied between each of the separator plates 2 and 3 and the elastic body 40.

FIG. 1B shows a state of the fuel battery component part manufactured by the manufacturing method of adhering each of the separator plates 2 and 3 to the elastic body 40 before being cured or after being primarily molded, pressing such that the gap 5 is provided between the contact surface 2a of one separator plate 2 and the contact surface 3a of another separator plate 3, and hardening the elastic body 40 for formation under this state in accordance with a heating process or the like. A heating condition at this time is different by the employed elastic material, however, the heating condition is appropriately set between 100 and 160° C. for the silicone group elastic material.

Further, a size D of the gap 5 is set such that a gap d1 of the gasket groove 6 (=height h of the elastic body 40) at a time of being formed is 101 to 150% of a gap d2 of the gasket groove 6 in a state in which the separator plates 2 and 3 are closely attached (or D=d1−d2 and d2<d1<1.50 d2), and preferably 105 to 130% (or D=d1−d2 and 1.05 d2<d1<1.30 d2). Accordingly, if the height h of the elastic body 40 is lower than the above range, the adhesion between the elastic body 40 and the separator plate 2 is insufficient, and if the height h of the elastic body 40 is higher than this range, the reaction force of the elastic body 40 is applied to the separator plates 2 and 3 more than necessity, so that there is a case that the separator plates 2 and 3 are broken.

FIG. 1C shows a state in which a pair of separator plates 2 and 3 are closely attached to each other in accordance with pressing at a time of assembling the fuel battery cell. As a method in this case, there is employed a method of pressing the entire of the structure in a state in which each of the component parts of the cell are laminated in accordance with a normal method of assembling the fuel battery cell, and fixing the structure.

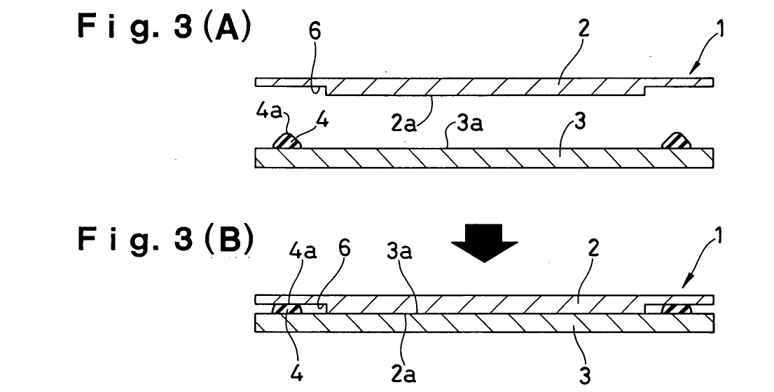

FIG. 3 shows a component part for a fuel battery in accordance with a comparative embodiment.

FIG. 3A shows a state in which the elastic body 40 having the chevron-shaped cross section is formed on the separator plate 3. In this stage, a hardening of the elastic body 40 for formation has already been finished in accordance with a heating process.

Further, FIG. 3B shows a state in which a pair of separator plates 2 and 3 are closely attached to each other in accordance with a pressing. Since the sealing is done by the chevron-shaped top end portion 4a of the gasket 4, there is a risk that the leakage of the fluid to be sealed is generated due to reduction of the reaction force.

The present invention achieves the following effects.

In accordance with the component part for the fuel battery provided with the structure mentioned above, since the gasket is adhered to each of a pair of separator plates in the component part for the fuel battery having a pair of the separator plates and the gasket interposed between both the separator plates, and being structured such that a pair of the separator plates are closely attached to each other at a time of assembling the cell, it is possible to form the gasket without limiting to the chevron cross sectional shape, whereby it is possible to form the gasket irrespective of the manufacturing method. In particular, in addition to the compression molding method and the injection molding method mentioned above, it is possible to employ the dispenser method, the screen printing method and the like which are comparatively simple.

Further, since the structure is made such that a pair of the separator plates are arranged in parallel with keeping the gap between the separators, and the gasket is compressedly deformed within the gasket groove at a time of closely attaching both the separator plates to each other for assembling the cell, a desired magnitude of gasket reaction force can be set by suitably regulating the size of the gap between a pair of the separator plates at a time of manufacturing. In particular, it is possible to set the gasket reaction force small as mentioned above.

Accordingly, it is possible to provide a separator product which can be comparatively easily manufactured, has the separator plate not to be broken by the reaction force, and is excellent in a sealing performance.

What is claimed is:

1. A component part for a fuel battery comprising:
a pair of separator plates which are arranged in parallel to each other in a state of having a gap between contact surfaces thereof opposing to each other; and
a gasket arranged in a gasket groove, which is provided in one or both of said separator plates, and adhered to each of both said separator plates,
wherein said gasket is compressedly deformed within said gasket groove at a time of both said separator plates being closely attached to each other with the contact surfaces for assembling of the fuel battery cell.
